(19) United States
(12) Patent Application Publication
(10) Pub. No.: US 2014/0315403 A1
(43) Pub. Date: Oct. 23, 2014

(54) ELECTRICAL CARD CONNECTOR WITH IMPROVED METAL SHELL

(71) Applicant: HON HAI PRECISION INDUSTRY CO., LTD., New Taipei (TW)

(72) Inventors: MING-QIU HAN, Kunshan (CN); FANG-YUE ZHU, Kunshan (CN); JIAN-FEI YU, Kunshan (CN); JIN-KUI HU, Kunshan (CN)

(73) Assignee: HON HAI PRECISION INDUSTRY CO., LTD., New Taipei (TW)

(21) Appl. No.: 14/155,385

(22) Filed: Jan. 15, 2014

(30) Foreign Application Priority Data
Apr. 18, 2013 (CN) 201320195745.9

(51) Int. Cl. H01R 13/648

(52) U.S. Cl. CPC H01R 13/6485
USPC 439/159

(57) ABSTRACT

An electrical card connector comprises an insulative housing, a plurality of contacts mounted to the insulative housing and a cover covering the insulative housing. The insulative housing defines a receiving space and a mounting wall in a rear of the receiving space. The contact has a contacting portion extending into the receiving space and a retaining portion retained to the mounting wall. The cover has a top wall covering a top of the receiving space. The contacts include a grounding contact, the top wall has an elastic finger extending therefrom and touching the grounding contact to achieve grounding. By this arrangement, the electrical card connector has an additional grounding path, and improves the performance of the electrical card connector.

### BACKGROUND OF THE INVENTION

1. Field of the Invention

The present invention relates to electrical card connectors, more particularly to an electrical card connector with improved metal shell.

2. Description of Related Art

Many different electrical card connectors are popularly used in electrical equipments for storing and transmitting data information. U.S. Pat. No. 6,840,807 discloses such an electrical card connector, which includes an insulative housing, a plurality of contacts received in the insulative housing, and a cover covering the insulative housing to define a receiving space together with the insulative housing for receiving an electrical card. The cover has a top wall and two side walls bent from the top wall, and each side wall has two metal ears for being soldered to a printed circuit board which is used to mount the electrical card connector to retain the electrical card connector. And usually, the metal ears are also used as grounding paths, however, the grounding trace on the printed circuit board for connecting with the metal ears may complex a design of the printed circuit board.

Hence, an improved electrical card connector is desired to overcome the above problems.

### BRIEF SUMMARY OF THE INVENTION

According to one aspect of the present invention, an electrical card connector comprises: an insulative housing, a plurality of conductive contacts received in the insulative housing, and a metal shell covering the insulative housing. The insulative housing defines a receiving space for receiving an electrical card and is formed with a mounting wall on a rear of the receiving space. Each of the conductive contacts is formed with a contacting portion extending into the receiving space and a retaining portion retained to the mounting wall. The conductive contacts have a grounding contact. The metal shell is formed with a top wall covering a top of the receiving space, an elastic finger is integrally and downwardly extending from the top wall to electrically contact the grounding contact.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an electrical card connector according to the present invention;

FIG. 2 is an another perspective view of the electrical card connector, wherein a metal shell is detached;

FIG. 3 is an exploded, perspective view of the electrical card connector shown in FIG. 1;

FIG. 4 is a view similar to FIG. 3, while taken from a different aspect;

FIG. 5 is a section view taken from line A-A of FIG. 1.

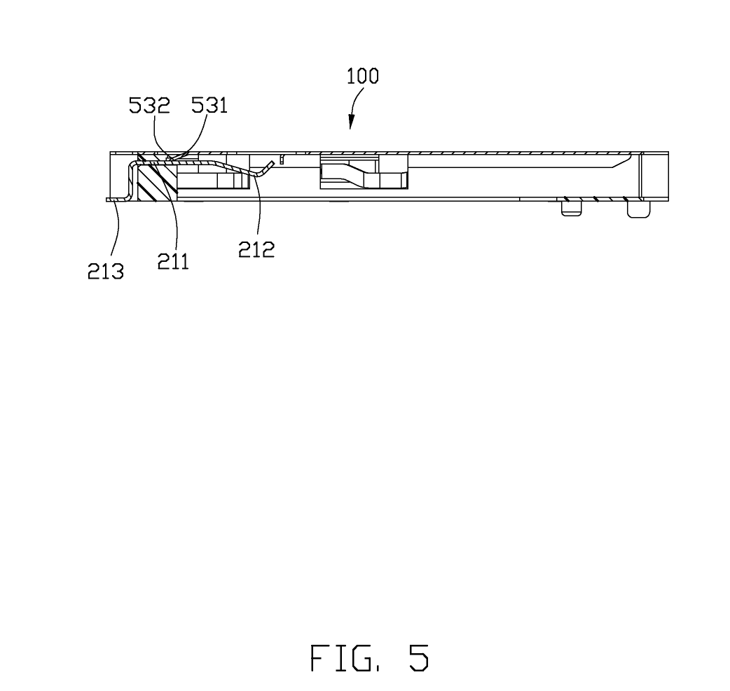

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

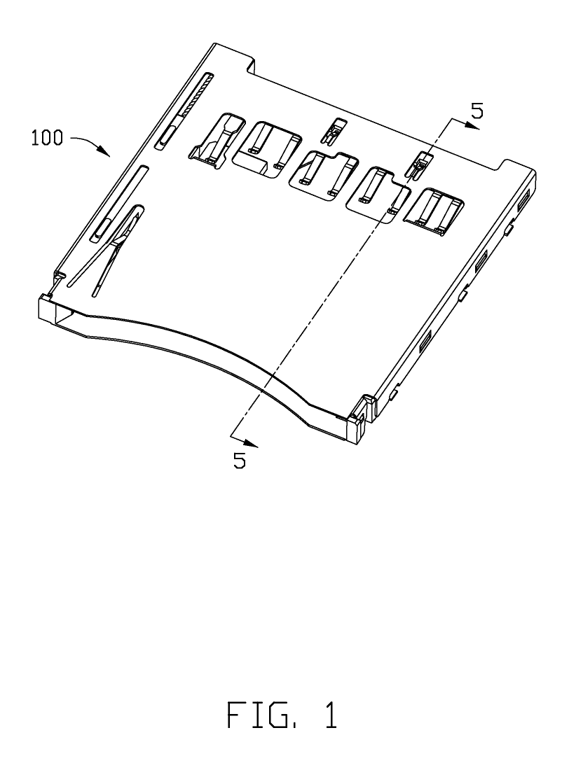

Referring to FIGS. 1-3, the electrical card connector 100 includes an insulative housing 1, a plurality of conductive contacts 2 received in the insulative housing 1, a detect element 3 assembled to the insulative housing 1, an ejector 4 and a metal shell 5 covering the insulative housing 1.

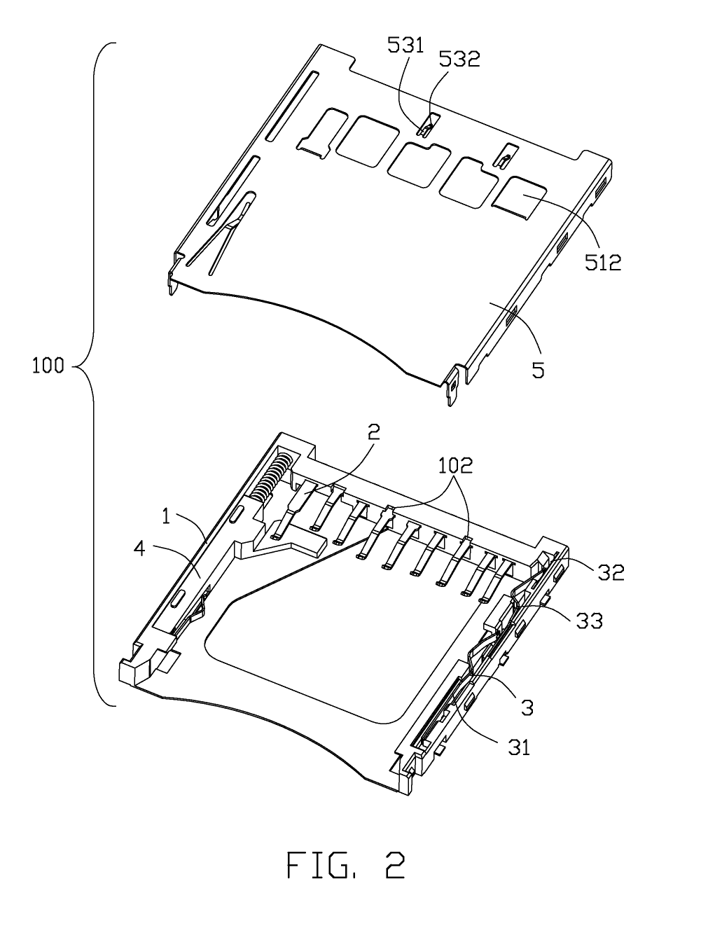

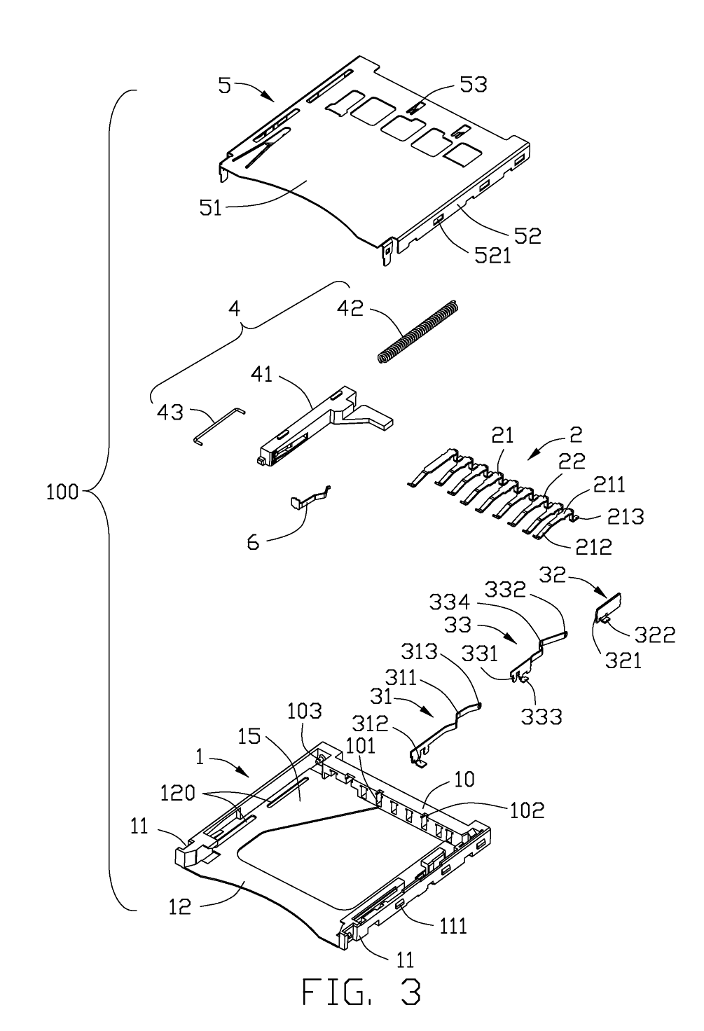

Referring to FIGS. 2-3, the insulative housing 1 defines a receiving space 15 for receiving the electrical card (not shown) and has a mounting wall 10 in a rear of the receiving space 15, two sidewalls 11 extending from two opposite ends of the mounting wall 10, and a bottom wall 12 connecting the two sidewalls 11. The receiving space 15 is surrounded by the mounting wall 10, the sidewalls 11 and the bottom wall 12.

The bottom wall 12 has two guiding slots 120 passing through the bottom wall 12 along a top to bottom direction and being used for guiding the ejector 4 to slider along a front to rear direction. The mounting wall 10 defines a plurality of retaining slots 101 which are arranged side by side and extend along the front to rear direction to retain the conductive contacts 2. A part of retaining slots 101 partially extending upwardly and through a front edge of the mounting wall 10 to define a plurality of gaps 102. The mounting wall 10 further has a position post 103 extending forwardly therefrom near the guiding slot 120. The sidewall 11 is formed with a plurality of protrusions 111 for engaging with the metal shell 5.

The conductive contact 2 has a retaining portion 211 retained in the retaining slot 101, a contacting portion 212 extending forwardly from the retaining portion 11 and extending into the receiving space 15 and a soldering portion 213 extending backwardly from the retaining portion 211 and out of the insulative housing 1. All contacting points of the contacting portion 212 of the conductive contacts 2 are located in a same surface. The conductive contacts 2 include 9 pins, from the left to right, the fourth pin is a first grounding pin 21 and the seventh pin is a second grounding pin 22. Both the retaining portions 211 of the first and the second grounding pins 21, 22 are exposed outside the insulative housing 1 by the gaps 102.

The detect element 3 is assembled to one of the sidewalls 11 on the right, the detect element 3 include a first detect pin 31 mounted on the front, a second detect pin 32 mounted on the rear and a common pin 33 located between the first and the second detect pins 31, 32. The first detect pin 31 has a first contact portion 311 contacting with the electrical card (not shown), a first soldering portion 312 soldered to a printed circuit board (not shown) and a first abutting portion 313 contacting with the common pin 33. The second detect pin 32 has a second abutting portion 321 contacting with the common pin 33 and a second soldering portion 322 soldered to the printed circuit board (not shown). The common pin 33 has a third abutting portion 331 contacting with the first detect pin 31 and a fourth abutting portion 332 contacting with the second detect pin 32, a third soldering portion 333 soldered to the printed circuit board (not shown) and a second contacting portion 334 contacting with the electrical card (not shown).

The electrical card (not shown) initially inserts into the receiving space 15, the first contacting portion 311 of the first detect pin 31 is pushed by the electrical card (not shown), and brings the first abutting portion 313 to contact with the third abutting portion 331 of the common pin 33 to achieve a first detection, then the inserting electrical card (not shown) pushes the second contacting portion 334 of the common pin 33, and the second contacting portion 334 brings the fourth abutting portion 332 of the common pin 33 to contact with the second abutting portion 321 to achieve a second detection.

Referring to FIG. 3, the ejector 4 has a slider 41 movably disposed on the bottom wall 12 of the insulative housing 1 and being able to slide within the guiding slot 120, a spring 42 with two ends resisting the insulative housing 1 and the slider 41, respectively, and a guider 43 for controlling the movement of the slider 41. An end of the spring 42 surrounds the position post 103. The guider 43 has an U shape, with one end retained to the sidewall 11 and the other end sliding in a heart groove recessed on the slider 41. A locking piece 6 is assembled to the slider 41 for locking the electrical card (not shown).

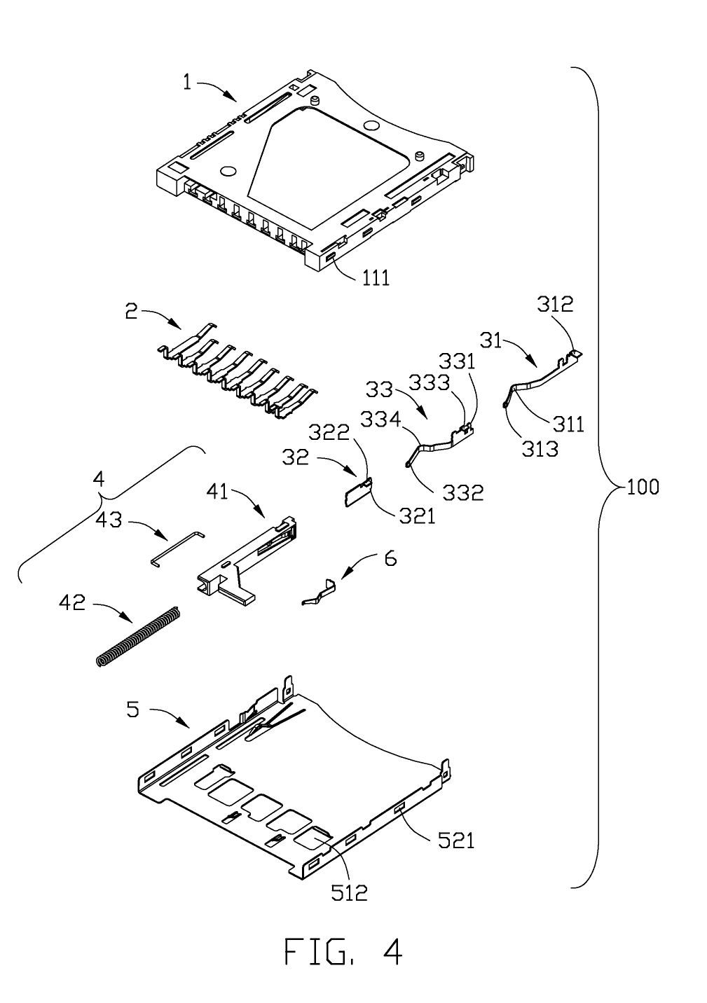

Referring to FIGS. 2-4, the metal shell 5 has a top wall 51 and two side walls 52 vertically and downwardly extending from the top wall 51. The side wall 52 defines a plurality of through latching holes 521 for latching with the protrusion 111 on the sidewall 11 to retain the metal shell 5 to the insulative housing 1. The top wall 51 further defines a plurality of first openings 512, the contacting portions 212 of the conductive contacts 2 are exposed from the openings 512, when the electrical card (not shown) inserts into the receiving space 15, the contacting portions 212 are upwardly pushed by the electrical card (not shown) and escape from the openings 512 to prevent the contacting portions 212 from touching the top wall 51 of the metal shell 5.

The top wall 51 is provided with two elastic fingers 53 at a rear side of the openings 512. One of the elastic fingers 53 is located above the first grounding contact 21 and the other is located above the second grounding contact 22. The elastic finger 53 has an extending portion 531 tore from the top wall 51 and extending into the receiving space 15 and a resisting portion 532 extending forwardly from an end of the extending portion 531, the resisting portion 532 extends into the gap 102 of the mounting wall 10 to contact with corresponding exposed portions of the retaining portions 211 of the first grounding contact 21 and the second grounding contact 22, which are exposed from the gap 102. Since the first and the second grounding contact 21, 22 electrically connect to grounding traces (not shown) on the printed circuit board (not shown), the metal shell 5 is also grounded via the elastic fingers 53 contact with the first and the second grounding contacts 21, 22.

In an alternative embodiment, the elastic finger may be formed on the retaining portion 211 of the grounding contact 21/22, and upwardly extends to contact with the top wall 51 of the metal shell 5 to build the grounding path.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical card connector comprising:
an insulative housing defining a receiving space for receiving an electrical card and formed with a mounting wall on a rear of the receiving space;
a plurality of conductive contacts received in the insulative housing, each of the conductive contacts formed with a contacting portion extending into the receiving space and a retaining portion retained to the mounting wall, the conductive contacts having a grounding contact; and
a metal shell covering the insulative housing, the metal shell formed with a top wall covering a top of the receiving space, an elastic finger integrally and downwardly extending from the top wall to electrically contact the grounding contact.

2. The electrical card connector as claimed in claim 1, wherein the mounting wall has a plurality of retaining slots passing through the mounting wall along a front to rear direction, the retaining portions of the conductive contacts are retained to the retaining slots, and the mounting wall further has a gap extending upwardly from a top of one of the retaining slot and through the mounting wall, the retaining portion of the grounding contact is exposed in the gap.

3. The electrical card connector as claimed in claim 2, wherein the elastic finger downwardly extends into the gap and electrically contacts with the retaining portion of the grounding contact.

4. The electrical card connector as claimed in claim 3, wherein the conductive contacts further comprise another grounding contact, and the top wall further has another elastic finger electrically contacting with the another grounding contact.

5. The electrical card connector as claimed in claim 4, wherein the top wall of the metal shell further has a plurality of openings to provide escaping channels for the contacting portions of the conductive contacts.

6. The electrical card connector as claimed in claim 4, wherein the elastic finger is tore from the top wall and has an extending portion extending into the receiving space and a resisting portion further extending from the extending portion, the resisting portion contacts with the retaining portion of the grounding contact.

7. An electrical card connector comprising:
an insulative housing defining a receiving space for receiving an electrical card and formed with a mounting wall on a rear of the receiving space, the mounting wall defining a plurality of retaining slots passing through the mounting wall along a front to rear direction;
a plurality of conductive contacts, each conductive contact formed with a contacting portion extending into the receiving space and a retaining portion retained to the retaining slot, the conductive contacts having a grounding contact; and
a metal shell formed with a top wall covering a top of the receiving space, the top wall and the retaining portion of the grounding contact electrically connecting with each other by an elastic finger.

8. The electrical card connector as claimed in claim 7, wherein the elastic finger is tore from the top wall.

9. The electrical card connector as claimed in claim 8, wherein the elastic finger has an extending portion extending into the receiving space and a resisting portion further extending from the extending portion, the resisting portion contacts with the retaining portion of the grounding contact.

10. The electrical card connector as claimed in claim 8, wherein the retaining portion of the grounding contact is exposed in a gap which extends upwardly from a top of corresponding retaining slot and through the mounting wall.

11. The electrical card connector as claimed in claim 10, wherein the top wall of the metal shell further has a plurality of openings to provide escaping channels for the contacting portions of the conductive contacts.

12. The electrical card connector as claimed in claim 7, wherein the elastic finger is integrally formed on the retaining portion of the grounding contact.

13. An electrical card connector comprising:
an insulative housing;
a metallic shell downwardly attached upon a top face of the housing in a vertical direction and cooperating with the housing to commonly define a card receiving space therebetween;
a plurality of contacts disposed in the housing with resilient deflectable contacting sections extending forwardly and downwardly into the card receiving space, said contacts including grounding contacts and signal contacts; and
a plurality of spring tangs unitarily extending from inner edges of the shell of corresponding openings of the shell, respectively, via a stamping process; wherein
each of said spring tang includes at a free end a resisting portion downwardly abutting against a stationary horizontal section of the corresponding grounding contact behind the resilient deflectable contacting section.

14. The electrical card connector as claimed in claim 13, wherein the housing defines a plurality of retaining slots to secure the corresponding contacts, respectively, and each of the retaining slots securing the grounding contacts is further equipped with an upward gap so as to allow the resisting portion to be downwardly inserted thereinto to contact the corresponding grounding contact,

15. The electrical card connector as claimed in claim 14, wherein the gap is located around a forward edge of the housing, and the corresponding spring tang extends rearwardly to allow the resisting portion to be protectively disposed in the gap.
